(19) United States
(12) Patent Application Publication
(10) Pub. No.: US 2025/0376139 A1
(43) Pub. Date: Dec. 11, 2025

(54) Hydraulic Brake System for Electric Work Machines

(71) Applicant: Caterpillar Global Mining Equipment LLC, Denison, TX (US)

(72) Inventors: Cameron T. Lane, Oro Valley, AZ (US); Michael Davies Hudson, Tucson, AZ (US); David William Engelhardt, Tucson, AZ (US); Karl P. Schneider, Decatur, IL (US); Andrew Olson, Vail, AZ (US)

(73) Assignee: Caterpillar Global Mining Equipment LLC, Denison, TX (US)

(21) Appl. No.: 18/923,240

(22) Filed: Oct. 22, 2024

Related U.S. Application Data
(60) Provisional application No. 63/657,593, filed on Jun. 7, 2024.

(51) Int. Cl. B60T 13/68; B60T 8/171; B60T 13/14; B62D 5/06; F16D 65/78

(52) U.S. Cl. CPC B60T 13/686; B60T 8/171; B60T 13/141; B62D 5/062; F16D 65/78; B60T 2220/00; B60T 2220/04; B60T 2260/08; B60T 2260/09; B60T 2270/402; F16D 2065/783

(57) ABSTRACT

A hydraulic brake system for a work machine is disclosed. The hydraulic brake system comprises a first hydraulic circuit including a first pump for providing fluid flow to a cooling system, a second hydraulic circuit including a second pump for providing fluid flow to a plurality of hydraulic systems, a valve configured to allow fluid flow from the second hydraulic circuit to the first hydraulic circuit, and a control unit configured to control the valve based on real-time braking requirements and signals received from a plurality of sensors disposed on the work machine.

### TECHNICAL FIELD

The present disclosure generally relates to electric work machines, and more particularly relates to hydraulic brake systems for electric work machines.

### BACKGROUND

Work machines, particularly those used in construction, mining, and other heavy industries, require effective braking systems to ensure safe and efficient operation. One critical aspect of such braking systems is the management of heat generated during braking. Excessive heat can lead to brake fade, reduced braking performance, and increased wear on braking components. Therefore, effective cooling systems are essential to maintain optimal brake functionality and extend the lifespan of brake components.

Traditionally, brake cooling systems in work machines have been designed to handle continuous braking capabilities. However, during high-demand situations such as prolonged or emergency braking, these systems may not provide sufficient cooling, leading to overheating and potential brake failure. This has led to the development of auxiliary cooling systems that can provide additional cooling capacity when needed, ensuring that the brakes remain within safe operating temperatures.

One example of a prior art that addresses brake cooling in work machines is DE102006036186A1, which discloses a vehicle cooling circuit equipped with an auxiliary coolant pump. This auxiliary pump is driven by a separate drive unit and is connected in parallel to the main cooling pump. The system includes a thermal switch or temperature sensor connected to a control device that activates or deactivates the auxiliary pump based on specific operating parameters. However, the prior art fails to provide separate cooling pumps for improved brake cooling in electric work machines.

Hence, it can therefore be seen that a need exists for a hydraulic brake system that not only addresses continuous braking capabilities but also provides additional cooling flow when necessary to prevent overheating and ensure reliable operation during high-demand braking scenarios.

### SUMMARY

In accordance with one aspect of the disclosure, a hydraulic brake system for a work machine is disclosed. The hydraulic brake system comprises a first hydraulic circuit including a first pump for providing fluid flow to a cooling system, a second hydraulic circuit including a second pump for providing fluid flow to a plurality of hydraulic systems, a valve configured to allow fluid flow from the second hydraulic circuit to the first hydraulic circuit, and a control unit configured to control the valve based on real-time braking requirements and signals received from a plurality of sensors disposed on the work machine.

In accordance with another aspect of the disclosure, a work machine is disclosed. The work machine comprises: a frame, ground engaging elements supporting the frame; a prime mover mounted on the frame; a hydraulic brake system for a battery electric machine including: a first hydraulic circuit including a first pump for providing fluid flow to a cooling system; a second hydraulic circuit including a second pump for providing fluid flow to a plurality of hydraulic systems; a valve configured to allow fluid flow from the second hydraulic circuit to the first hydraulic circuit; and a control unit configured to control the valve based on real-time braking requirements and signals received from a plurality of sensors disposed on the work machine.

In accordance with another aspect of the disclosure, a method is disclosed for controlling a hydraulic brake system of a battery electric machine. The method comprises: sensing, via a control unit, real-time braking requirements based on signals received from a plurality of sensors; pumping hydraulic fluid through a first hydraulic circuit to a cooling system; pumping hydraulic fluid through a second hydraulic circuit to a plurality of hydraulic systems; adjusting a valve position of a valve, via the control unit, to allow fluid flow from the second hydraulic circuit to the first hydraulic circuit based on the real-time braking requirements.

These and other aspects and features of the present disclosure will be better understood upon reading the following detailed description when read in conjunction with the accompanying drawings.

### BRIEF DESCRIPTION OF THE DRAWINGS

FIG. 1 is a perspective view of a work machine, according to an embodiment of the present disclosure.

FIG. 2 is a schematic diagram illustrating a brake control system, according to an embodiment of the present disclosure.

FIG. 3 is a block diagram illustrating a hydraulic brake system, according to another embodiment of the present disclosure.

FIG. 4 is a block diagram illustrating a second hydraulic brake system, according to another embodiment of the present disclosure.

FIG. 5 is a schematic a hydraulic brake system of the work machine of FIG. 1, according to an embodiment of the disclosure.

FIG. 6 is a flow chart of the method for cycling between hydraulic auxiliary, according to another embodiment of the present disclosure.

The figures depict one embodiment of the presented disclosure for purposes of illustration only. One skilled in the art will readily recognize from the following discussion that alternative embodiments of the structures and methods illustrated herein may be employed without departing from the principles described herein.

### DETAILED DESCRIPTION

Referring now to the drawings, and with specific reference to the depicted example, a work machine 100 is shown, illustrated as an exemplary battery electric machine equipped with a hydraulic brake system. While the following detailed description describes an exemplary aspect in connection with the battery electric machine, it should be appreciated that the description applies equally to the use of the present disclosure in other hydraulic systems, including, but not limited to, electric vehicles, hybrid machines, industrial equipment, and heavy-duty construction machinery.

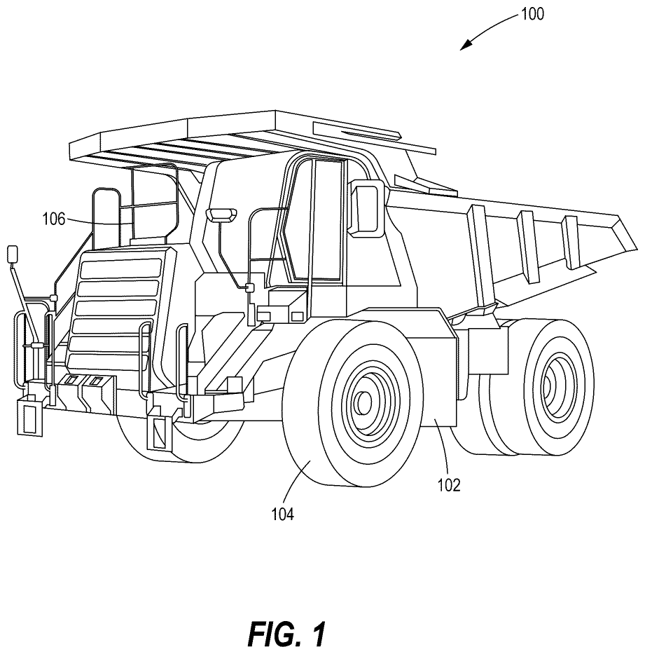

Referring now to the drawings, FIG. 1 illustrates a perspective view of a work machine 100, according to an embodiment of the present disclosure. The work machine 100 includes a frame 102, which supports various operational components of the machine. The frame 102 is mounted on ground engaging elements 104, which in this embodiment are illustrated as wheels, but could alternatively be continuous tracks or any other suitable ground engaging elements. The work machine 100 further includes a cabin 106 for an operator to control the machine. In other work machines, extending from the frame 102 is a working arm (not shown), such as an excavator arm or boom, designed for performing tasks such as lifting, digging, or other work-related activities via a work implement attached to the working arm.

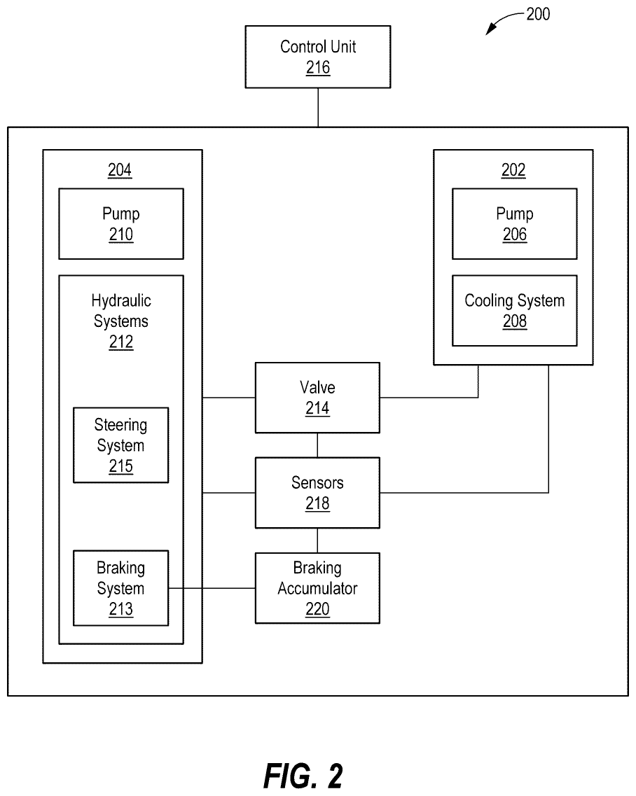

Referring to FIG. 2, a schematic diagram illustrating a brake control system 200, according to an embodiment of the present disclosure, is shown. The brake control system 200 is integrated within the work machine 100 and is designed to provide efficient braking and cooling functionalities.

The brake control system 200 includes a first hydraulic circuit 202 and a second hydraulic circuit 204. The first hydraulic circuit 202 comprises a first pump 206 that provides hydraulic fluid flow to a cooling system 208. The cooling system 208 manages the temperature of various components within the brake control system 200 and work machine 100, ensuring optimal operating conditions and preventing overheating during movements and stoppages of the ground engaging elements 104 of the work machine 100.

The second hydraulic circuit 204 includes a second pump 210, which supplies hydraulic fluid to a plurality of machine hydraulic systems 212, such as braking system 213 and a steering system 215. The braking system 212 is responsible for applying braking forces to the ground engaging elements 104 of the work machine 100. The braking system 213 includes components such as brake disks and brake pistons (not shown) which engage to slow down or stop the machine. The plurality of machine hydraulic systems 212 may include a plurality of machine functions such as hydraulic steering columns or for hydraulically powering other accessory components such as hydraulic powered work implements.

A valve 214, which is configured to allow fluid flow from the second hydraulic circuit 204 to the first hydraulic circuit 202. This valve 214 enables the hydraulic fluid to be redirected based on the operational requirements of the machine, such as during intense braking scenarios where additional cooling may be necessary.

The operation of the brake control system 200 is governed by a control unit 216. The control unit 216 governs the valve 214 and receives real-time data from a plurality of sensors 218 distributed throughout the work machine 100. These sensors 218 include, but are not limited to, wheel speed sensors, hydraulic pressure sensors, machine grade sensors, inertial measurement unit sensors, payload sensors, pressure sensors, and temperature sensors. Based on the input from the plurality of sensors 218, the control unit 216 adjusts the position of the valve 214 to optimize the performance of both the braking and cooling systems.

Additionally, the brake control system 200 includes a braking accumulator 220 connected to the braking system 213. The braking accumulator 220 stores hydraulic fluid under pressure, which can be utilized for emergency braking situations, ensuring that the machine can be brought to a stop safely even if the first pump 206 or the second pump 210 fails.

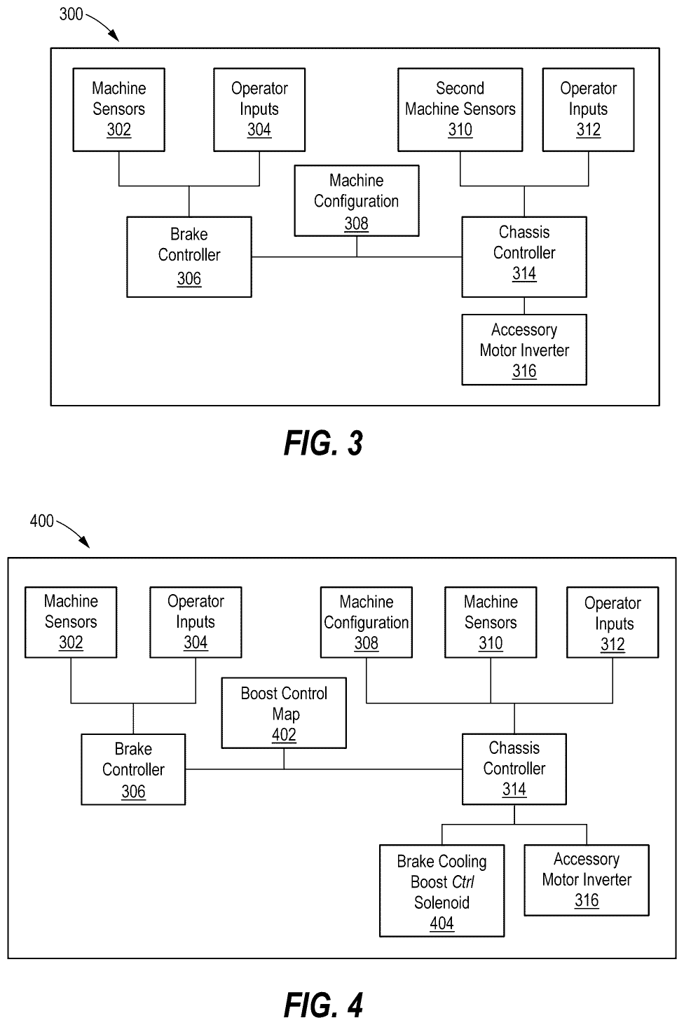

Referring now to FIG. 3, a block diagram illustrating a brake control flow 300, according to an embodiment of the present disclosure, is shown. The brake control flow 300 integrates various sensors, operator inputs, and control mechanisms to manage and optimize the braking performance of a battery electric machine.

The system comprises Machine Sensors 302, which monitor critical parameters such as brake oil temperatures, machine speed, machine payload, machine geometric grade (IMU), and brake pressures. These inputs are crucial for real-time adjustment and control of the braking system. Operator Inputs 304 include the service brake pedal, secondary brake pedal, brake lever, and automated retarding control “ARC” speed setpoint, allowing the operator to directly influence the braking system based on operational needs. The machine sensors 302 may be a part of the plurality of sensors 218.

A Brake Controller 306, which processes data from the machine sensors 302 and operator inputs 304 to predict brake plate temperatures, calculates machine kinetic energy and grade, determine braking torque command, and assess machine rolling resistance. The brake controller 306 ensures that the braking system responds appropriately to varying conditions. The brake controller 306 may also processes data from the machine sensors 302 and operator inputs 304 to predict component temperatures. The control unit 216 may also processes data from the machine sensors 302 and operator inputs 304 to predict component temperatures and component pressures in the work machine 100.

The Machine Configuration 308 includes details about pump displacement and pump motor size, used to configure the hydraulic pumps for optimal performance based on the machine's design and operational parameters. Machine Sensors 310 provide data on hydraulic pump speed, brake accumulator pressure, and steering accumulator pressure, offering critical inputs for fine-tuning the braking and cooling systems.

Operator Inputs 312 include the hoist lever and throttle pedal, providing further control inputs that can influence the machine's overall braking and operational performance. The Chassis Controller 314 receives inputs from the brake controller 306, machine configuration 308, machine sensors 310, and operator inputs 312. Chassis Controller 314 manages hydraulic pump speed commands, ensuring efficient operation of the braking system.

An Accessory Motor Inverter 316 controls the speed of accessory motors based on commands from the chassis controller 314, ensuring that auxiliary systems work in harmony with the braking system. The accessory motor inverter 316 is responsible for driving the hydraulic pumps, the first pump 206 and the second pump 210, that supply fluid to both the braking and cooling systems. By precisely controlling the speed of the accessory motor inverter 316, the accessory motor inverter 316 ensures that the hydraulic pumps, the first pump 206 and the second pump 210, operate efficiently, providing the necessary hydraulic pressure and flow rate to meet the varying demands of the braking and cooling systems. The coordination supports maintaining optimal performance and safety of the work machine, as it allows for real-time adjustments to the hydraulic systems based on operational requirements.

The flow of information in the brake control flow 300 is structured as follows: Data from the machine sensors 302 and operator inputs 304 are processed by the brake controller 306. The brake controller 306, along with machine configuration 308 and machine sensors 310, sends information to the chassis controller 314, which also receives further operator inputs 312. The chassis controller 314 then communicates with the accessory motor inverter 316 to adjust the accessory motor speed as needed. This integrated approach ensures the braking system operates efficiently and effectively, adapting to real-time conditions and operator commands.

Referring now to the drawings, FIG. 4 is a block diagram illustrating a boost brake control flow 400, according to an embodiment of the present disclosure. This system builds upon the foundational elements of the brake control flow 300 by incorporating additional components to enhance braking performance through a boost mechanism.

The boost brake control flow 400 integrates key elements from the brake control flow 300, including Machine Sensors 302, which monitor parameters like brake oil temperatures, machine speed, machine payload, machine geometric grade (IMU), and brake pressures. Operator Inputs 304 such as the service brake pedal, secondary brake pedal, brake lever, and ARC speed setpoint provide direct control inputs. The Brake Controller 306 processes these inputs to manage brake plate temperature prediction, machine kinetic energy, grade, braking torque command, and rolling resistance. Additionally, Machine Configuration 308 provides pump displacement and pump motor size details, while Machine Sensors 310 monitor hydraulic pump speed, brake accumulator pressure, and steering accumulator pressure. Further Operator Inputs 312 include the hoist lever and throttle pedal, offering additional operational control.

To enable the boost functionality, the system includes a Boost Control Map 402. The Boost Control Map 402 uses machine kinetic energy, grade, machine brake torque command, and a calibrated map of thresholds to determine when additional brake cooling is necessary. Both the kinetic energy and brake torque conditions must exceed their respective thresholds to activate the boost function.

Incorporating these inputs, the Chassis Controller 314 manages hydraulic pump speed commands, integrating data from the brake controller 306, machine configuration 308, machine sensors 310, operator inputs 312, and the boost control map 402.

When boost conditions are met, the chassis controller 314 activates a Brake Cooling Boost Control Solenoid 404 to provide extra cooling capacity. Specifically, the Brake Cooling Boost Control Solenoid 404 directs additional hydraulic fluid to the brake cooling system, significantly enhancing its cooling capability. This action ensures that the braking system remains within optimal temperature ranges even during high-demand scenarios such as prolonged braking or emergency stops. By activating the Brake Cooling Boost Control Solenoid 404, the brake control system 200 can quickly respond to the increased thermal load, thereby preventing overheating and maintaining braking efficiency and safety.

The flow of information in the boost brake control flow 400 is as follows: Data from machine sensors 302 and operator inputs 304 are processed by the brake controller 306. The brake controller 306, together with machine configuration 308, machine sensors 310, and operator inputs 312, sends information to the chassis controller 314. The chassis controller 314 also incorporates input from the boost control map 402. The chassis controller 314 then communicates with the accessory motor inverter 316 or the brake cooling boost control solenoid 404 to adjust the system accordingly. This integrated approach ensures the braking system operates efficiently, with the ability to respond to increased demands through the boost function, maintaining optimal performance and safety.

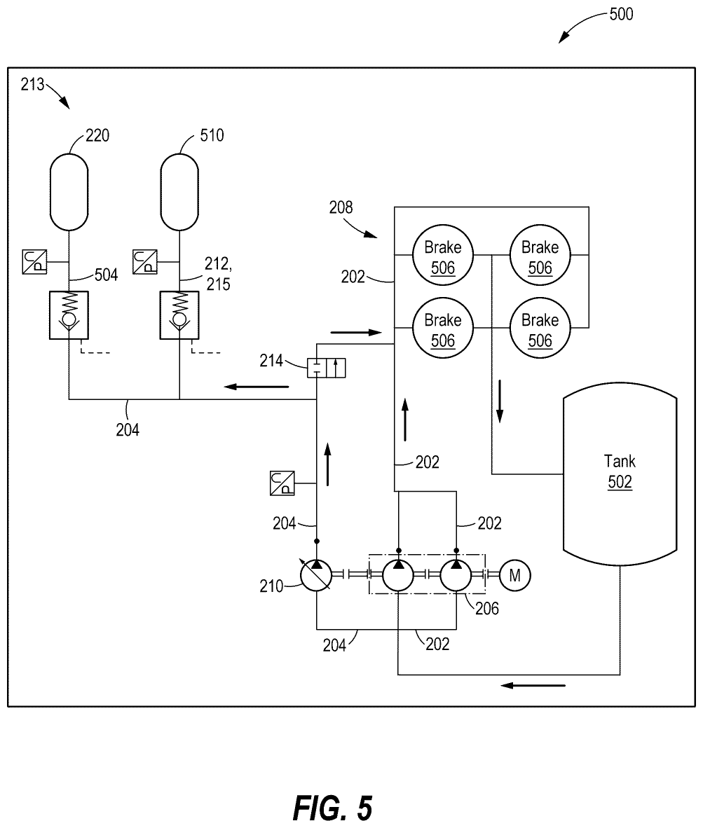

Referring now to FIG. 5, this figure illustrates a schematic of a hydraulic brake system 500, according to an embodiment of the present disclosure. The hydraulic brake system 500 is designed to ensure that the braking components of the machine are kept within optimal temperature ranges during operation, thereby maintaining efficiency and safety.

The hydraulic brake system 500 includes a Tank 502, which stores the hydraulic fluid used in both the braking and steering systems. Hydraulic fluid from the tank 502 is pumped into the system and distributed to various components as needed. The hydraulic brake system 500 includes the braking system 212 having a brake actuation system 504 responsible for applying a plurality of brakes 506 when the control unit 216 receives a braking command or braking requirement, such as an operator input or actuation of a brake pedal. The hydraulic brake system 500 includes various hydraulic components that pressurize the hydraulic brake fluid to engage the plurality of brakes 506.

The hydraulic brake system 500 includes a steering system 508, which controls the direction of the work machine 100. The hydraulic brake system 500 is integrated with the brake control system 200 to ensure coordinated control of both braking and steering operations of the work machine 100.

The plurality of brakes 506 are the actual braking components that engage the ground engaging elements 104 to slow down or stop the work machine 100. These plurality of brakes 506 are distributed across the work machine 100 to provide balanced braking force against the ground engaging elements 104, such as wheels, tires, or continuous tracks.

To maintain the necessary hydraulic pressure, the system incorporates one or more accumulators, such as the braking accumulator 220 and a Hydraulic accumulator 510, which may be a steering accumulator or any hydraulic accumulator connected to the plurality of hydraulic systems 212 in the work machine 100. The accumulators store hydraulic fluid under pressure, ensuring that there is always sufficient fluid available for both braking functions, steering functions, and machine hydraulic functions, even during high-demand situations.

The first hydraulic circuit 202 and the second hydraulic circuit 204 are integrated into the hydraulic brake system 500. The first hydraulic circuit 202 includes the first pump 206 that provides hydraulic fluid to the cooling system 208, which is responsible for managing the temperature of the braking components, the plurality of brakes 506, and or a hoist (not shown).

The second hydraulic circuit 204 includes the second pump 210 that supplies hydraulic fluid to the braking system 212 and the brake actuation system 504. The second pump 210 ensures that the plurality of brakes 506 receive adequate hydraulic fluid pressure to function effectively.

The hydraulic brake system 500 further includes the valve 214, strategically positioned to allow fluid flow from the second hydraulic circuit 204 to the first hydraulic circuit 202 when additional cooling is required. The valve 214 can be an electronic solenoid valve or proportional valve, allowing precise control of fluid flow between the circuits based on operational demands.

The operation of the valve 214 is controlled by the control unit 216, which receives input from a plurality of sensors 218 distributed throughout the machine. The plurality of sensors 218 monitor various parameters such as hydraulic pressure, brake temperature, vehicle speed, and brake pedal position. Based on real-time data from these sensors, the control unit 216 adjusts the position of the valve 214 to optimize the performance of both the braking and cooling systems.

Additionally, the hydraulic brake system 500 includes the braking accumulator 220 and the hydraulic accumulator 510 connected to the respective hydraulic circuits. These accumulators store pressurized hydraulic fluid, providing an immediate source of hydraulic pressure for emergency braking and steering situations, thus enhancing the safety and reliability of the hydraulic brake system 500. The fluid from the tank 502 is circulated through the brake actuation system 504 and the steering system 508, with the braking accumulator 220 and the hydraulic accumulator 510 providing necessary pressure support. This coordinated system ensures that the machine operates safely and efficiently under various operating conditions, maintaining optimal braking performance and cooling capacity.

The hydraulic brake system 500 integrates the tank 502, steering system 508, brake actuation system 504, a plurality of brakes 506, brake accumulator 220, and hydraulic accumulator 510, along with the first hydraulic circuit 202, second hydraulic circuit 204, the first pump 206, the cooling system 208, the second pump 210, the braking system 212, the valve 214, the tank 502, the brake actuation system 504, the plurality of brakes 506, the steering system 508, and the hydraulic accumulator 510, each monitored by the plurality of sensors 218 which send and receive signals to the control unit 216 for controlling the hydraulic brake system 500.

### INDUSTRIAL APPLICABILITY

The present disclosure finds applicability in a variety of industries, particularly in the fields of battery electric machines and heavy-duty machinery requiring efficient braking and cooling systems. The described hydraulic brake system is designed to maintain optimal braking performance and cooling efficiency under various operational conditions, making it suitable for use in electric vehicles, hybrid machines, industrial equipment, and heavy-duty construction machinery.

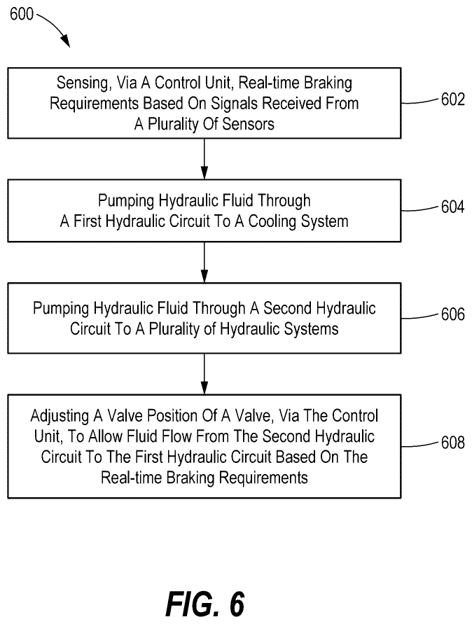

Referring now to FIG. 6, this figure illustrates a flow chart of a method 600 for controlling a hydraulic brake system of a battery electric machine, according to an embodiment of the present disclosure. The method 600 comprises several steps to ensure the efficient operation of the hydraulic brake system.

A Step 602 involves sensing, via a control unit 216, real-time braking requirements based on signals received from a plurality of sensors 218. These sensors 218 monitor various parameters such as wheel speed, hydraulic pressure, and temperature, providing crucial data to the control unit 216.

A Step 604 includes pumping hydraulic fluid through a first hydraulic circuit 202 to the cooling system 208. The cooling system 208 manages the temperature of the braking components, preventing overheating and maintaining optimal operating conditions.

A Step 606 involves pumping hydraulic fluid through a second hydraulic circuit 204 to the braking system 212 when the brake actuation system 504 is actuated. The braking system 212 ensures that the plurality of brakes 506 receive the necessary hydraulic pressure to function effectively.

A Step 608 entails adjusting the valve position of the valve 214, via the control unit 216, to allow fluid flow from the second hydraulic circuit 204 to the first hydraulic circuit 202 based on the real-time braking requirements. This adjustment helps balance the hydraulic fluid distribution between braking and cooling needs.

Furthermore, the method includes additional steps to enhance the system's performance. In one aspect, the method involves receiving signals from a braking pressure sensor and a cooling system temperature sensor, both of which are part of the plurality of sensors 218. Based on these signals, the control unit 216 adjusts the valve position to optimize both braking performance and cooling efficiency. This ensures that the system can adapt to varying operational demands, maintaining both safety and efficiency.

The control unit 216 is programmed with algorithms that determine valve adjustments based on predefined braking and cooling thresholds. These algorithms enable the control unit 216 to make precise adjustments to the valve 214 position, ensuring that the system operates within optimal parameters at all times.

Additionally, the method involves continuously monitoring braking and cooling conditions via a feedback loop in the control unit 216. This feedback loop allows the control unit 216 to dynamically adjust the valve 214 position in real-time, responding to changes in operational conditions to maintain optimal system performance.

The hydraulic brake system described herein integrates advanced control mechanisms and sensor data from the plurality of sensors 218 to provide a robust solution for managing braking and cooling in battery electric machines. The described method ensures that the system can efficiently respond to real-time demands, optimizing performance and maintaining safety across various operational scenarios. The hydraulic brake system 500, incorporating elements such as the tank 502, steering system 508, brake actuation system 504, plurality of brakes 506, braking accumulator 220, and hydraulic accumulator 510, works in concert with the first hydraulic circuit 202, second hydraulic circuit 204, the first pump 206, the second pump 210, valve 214, control unit 216, and sensors 218 to ensure safe and efficient operation under varying conditions.

From the foregoing, it can be seen that the technology disclosed herein has significant industrial applicability in a variety of settings, including but not limited to construction, mining, and quarrying industries that require robust, flexible, and efficient hydraulic brake systems. This adaptability ensures that the hydraulic brake system can meet the evolving demands of these industries while supporting sustainable operational practices.

What is claimed is:

1. A hydraulic brake system for a work machine, comprising:
a first hydraulic circuit including a first pump for providing fluid flow to a cooling system;
a second hydraulic circuit including a second pump for providing fluid flow to a plurality of hydraulic systems;
a valve configured to allow fluid flow from the second hydraulic circuit to the first hydraulic circuit; and
a control unit configured to control the valve based on real-time braking requirements and signals received from a plurality of sensors disposed on the work machine.

2. The hydraulic brake system of claim 1, wherein the control unit is further configured to control the valve based on receive signals from an operator; and wherein the plurality of hydraulic systems includes at least one chosen from the group consisting of from a braking system, a steering system, and a work implement system.

3. The hydraulic brake system of claim 2, wherein the control unit is programmed with a set of algorithms that determine valve adjustments based on automated control system requirements.

4. The hydraulic brake system of claim 3, wherein the control unit includes a feedback loop that continuously monitors braking and cooling conditions and adjusts the valve position in real-time.

5. The hydraulic brake system of claim 1, further comprising a braking accumulator connected to the first hydraulic circuit, the accumulator being configured to store hydraulic fluid under pressure for emergency braking situations.

6. The hydraulic brake system of claim 1, wherein the valve is a solenoid valve, allowing for variable fluid flow between the first and second hydraulic circuits based on the commands of the control unit.

7. The hydraulic brake system of claim 1, further comprising a steering system and a steering accumulator, the second pump providing fluid flow to the steering system.

8. The hydraulic brake system of claim 1, wherein the plurality of sensors includes at least one chosen from the group consisting of wheel speed sensors, hydraulic pressure sensors, machine grade sensors, IMU sensors, steering column sensors, and temperature sensors distributed throughout the braking and cooling systems.

9. A work machine comprising:
a frame;
ground engaging elements supporting the frame;
a prime mover mounted on the frame;
a hydraulic brake system for a battery electric machine including:
a first hydraulic circuit including a first pump for providing fluid flow to a cooling system;
a second hydraulic circuit including a second pump for providing fluid flow to a plurality of hydraulic systems;
a valve configured to allow fluid flow from the second hydraulic circuit to the first hydraulic circuit; and
a control unit configured to control the valve based on real-time braking requirements and signals received from a plurality of sensors disposed on the work machine.

10. The work machine of claim 9, wherein the control unit is further configured to control the valve based on receive signals from an operator; and wherein the plurality of hydraulic systems includes at least one chosen from the group consisting of from a braking system, a steering system, and a work implement system.

11. The work machine of claim 9, wherein the control unit is programmed with a set of algorithms that determine valve adjustments based on predefined braking and cooling thresholds.

12. The work machine of claim 9, wherein the control unit includes a feedback loop that continuously monitors braking and cooling conditions and adjusts the valve position in real-time.

13. The work machine of claim 9, further comprising a braking accumulator connected to the first hydraulic circuit, the accumulator being configured to store hydraulic fluid under pressure for emergency braking situations.

14. The work machine of claim 9, wherein the valve is a proportional valve, allowing for variable fluid flow between the first and second hydraulic circuits based on the commands of the control unit.

15. The work machine of claim 9, further comprising a steering system and a steering accumulator, the second pump providing fluid flow to the steering system.

16. The work machine of claim 9, wherein the plurality of sensors includes at least one chosen from the group consisting of wheel speed sensors, hydraulic pressure sensors, machine grade sensors, IMU sensors, steering column sensors, and temperature sensors distributed throughout work machine.

17. A method for controlling a hydraulic brake system of a battery electric machine, comprising:
sensing, via a control unit, real-time braking requirements based on signals received from a plurality of sensors;
pumping hydraulic fluid through a first hydraulic circuit to a cooling system;
pumping hydraulic fluid through a second hydraulic circuit to a plurality of hydraulic systems;
adjusting a valve position of a valve, via the control unit, to allow fluid flow from the second hydraulic circuit to the first hydraulic circuit based on the real-time braking requirements.

18. The method of claim 17, further comprising:
receiving signals from the plurality of sensors, the plurality of sensors includes at least one chosen from the group consisting of wheel speed sensors, hydraulic pressure sensors, machine grade sensors, IMU sensors, steering column sensors, and temperature sensors distributed throughout work machine; and
adjusting the valve position to optimize both braking performance and cooling efficiency based on these signals.

19. The method of claim 18, wherein the control unit is programmed with algorithms that determine valve adjustments based on predefined braking and cooling thresholds.

20. The method of claim 17, further comprising:
continuously monitoring braking and cooling conditions via a feedback loop in the control unit; and
dynamically adjusting the valve position in real-time to maintain optimal system performance.
